(19) United States
(12) Patent Application Publication
(10) Pub. No.: US 2026/0258330 A1
(43) Pub. Date: Sep. 3, 2026

(54) USE OF AT LEAST ONE AMPHIDINOL IN A BEVERAGE, IN PARTICULAR AN ALCOHOLIC BEVERAGE, AS A SUBSTITUTE FOR SULPHITES

(71) Applicants: IMMUNRISE BIOCONTROL FRANCE, CESTAS (FR); BARON PHILIPPE DE ROTHSCHILD, PAUILLAC (FR)

(72) Inventors: Erick TOURBIER, CARCANS (FR); Odon THIEBEAULD DE LA CROUEE, BOURG LA REINE (FR); Charlotte DEGRAEVE, CANEJAN (FR)

(21) Appl. No.: 19/490,014

(22) PCT Filed: Jun. 7, 2024
(86) PCT No.: PCT/EP2024/065741

§ 371 Date: Dec. 18, 2025

(30) Foreign Application Priority Data
Jun. 7, 2023 (FR) FR2305735

(51) Int. Cl. C12H 1/14; A23B 70/10

(52) U.S. Cl. CPC C12H 1/14; A23B 70/10

(57) ABSTRACT

The present invention relates to the use of a product comprising at least one amphidinol in an alcoholic beverage or in a non-alcoholic beverage, to a product intended for use in alcoholic beverages or non-alcoholic beverages, to a particular alcoholic or non-alcoholic beverage and a method for producing same. The present invention aims to provide a new means for preventing unwanted microorganisms in alcoholic or non-alcoholic beverages while having no impact on the organoleptic qualities of said beverages, in order to obtain an alcoholic or non-alcoholic beverage without added sulfites and without an adverse effect on flavor.

### TECHNICAL FIELD

The invention relates to the technical field of sulfite substitutes, notably in alcoholic beverages. In particular, the invention relates to the use of a product comprising at least one amphidinol in an alcoholic beverage or in a non-alcoholic beverage, to a product intended for use in beverages, in particular alcoholic beverages comprising amphidinols, to a particular alcoholic or non-alcoholic beverage and to a method of making same.

### STATE OF THE ART

Sulfites are chemical compounds containing sulfur and oxygen. Because of their ability to inhibit the growth of unwanted microorganisms and their antioxidant properties, they are widely used in the food industry.

In alcoholic beverages and certain non-alcoholic beverages, sulfites may form naturally during fermentation or may be added during the method of making same.

Natural sulfites are found in variable amounts in alcoholic beverages, and their content depends on various parameters such as the type of beverage, the fermentation time and the storage conditions.

Added sulfites, on the other hand, are additional sulfites added to the alcoholic beverage during or after fermentation to increase the stability and the shelf life. Added sulfites may be in the form of sulfur dioxide or sulfites, notably potassium sulfite.

For example, added sulfites, such as notably sulfur dioxide (SO2), can be used to control yeasts and other undesirable micro-organisms in alcoholic beverages.

In particular, the use of SO2 is currently the most widely used means for preventing the development of Brettanomyces bruxellensis, which is considered a particularly unwanted microorganism in alcoholic beverages and wine in particular. Indeed, the uncontrolled presence of Brettanomyces species in alcoholic beverage manufacturing processes is problematic insofar as this yeast is responsible for the irreversible degradation of the organoleptic qualities of said beverages, such as wine or beer. The Brettanomyces bruxellensis species is usually associated with the odors of poster paint, cloves, leather, horse sweat and stables due to the production of volatile phenols, substantially 4-ethylphenol and 4-ethylguaiacol.

The use of sulfites, such as SO2, therefore helps to slow the development of Brettanomyces bruxellensis in alcoholic beverages while also controlling other microorganisms such as Saccharomyces cerevisiae and/or bacteria and providing an antioxidant effect.

However, chemicals such as added sulfites are difficult to break down: they end up in processed alcoholic beverages and are ingested by consumers. Yet, sulfites have a negative impact on human health, not least because of their allergenic properties.

Furthermore, the use of added sulfites is becoming increasingly controversial due to the emergence of resistance. Recent studies have shown that the Brettanomyces species has a high degree of genetic diversity, enabling a certain number of strains of the Brettanomyces species to resist and survive sulfites.

Thus, the use of sulfites to control unwanted microorganisms such as the Brettanomyces species in alcoholic beverages is therefore showing its limits and more natural alternative solutions are therefore needed.

To replace the sulfites, it is possible to use physical treatments as means of combating unwanted microorganisms in alcoholic beverages, but these treatments are used curatively when contamination is detected and cannot be used preventively. Additionally, the implementation of physical treatment, such as microfiltration, within alcoholic beverage manufacturing methods can be expensive and can affect the organoleptic qualities of said beverages. However, in the field of alcoholic beverages, it is particularly important not to affect the aromas and the texture of the beverage.

Alternatives are also emerging with the use of natural molecules to control unwanted bacteria and/or yeasts.

Chitosan is a natural yeast-killing molecule which has a biocidal action against the yeast Brettanomyces bruxellensis but which has no action against Saccharomyces cerevisiae. Furthermore, some strains of Brettanomyces bruxellensis are insensitive to the action of chitosan. This yeasticide is therefore not suitable for the treatment of beverages, notably alcoholic beverages, particularly to replace sulfites.

There is therefore a need for new means of combating unwanted microorganisms in beverages, in particular alcoholic beverages, adapted to the specific conditions of beverages such as the presence of alcohol, with no impact on their organoleptic qualities, in order to obtain a beverage, in particular an alcoholic beverage, without added sulfites, without an adverse effect on flavor.

### SUMMARY OF THE INVENTION

In their search for sulfite substitutes, the inventors discovered that adding at least one amphidinol to a beverage, in particular an alcoholic beverage, helped to prevent and/or combat unwanted microorganisms present in said beverage, while at the same time providing an antioxidant effect and preserving its organoleptic qualities.

Thus, the object of the invention is a product comprising at least one amphidinol for use in an alcoholic beverage or in a non-alcoholic beverage.

Amphidinols are organic compounds produced by certain species of dinoflagellates and marine microorganisms.

By way of example, the structures of amphidinol 18 and amphidinol 19 are given below:

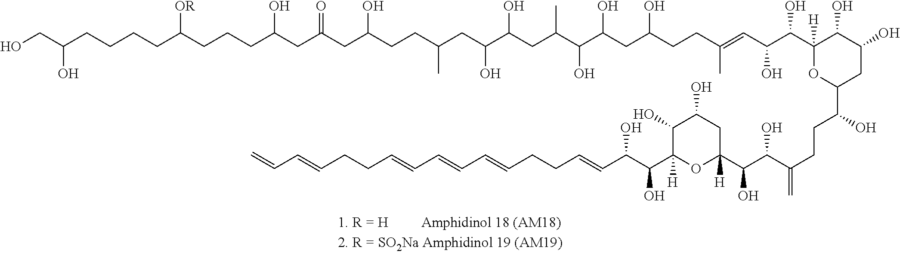

Amphidinols are polyhydroxy-polyenes (long-chain polyketides) known for a variety of biological activities, notably anticancer, antifungal and antiviral properties.

Surprisingly, the inventors have demonstrated:
the effect of amphidinols on controlling the growth of unwanted microorganisms in alcoholic and non-alcoholic beverages, notably on yeasts belonging to the genera Brettanomyces and Saccharomyces and/or on bacteria of the genera Acetobacter, Oenococcus and Pediococcus,
the resistance of amphidinols to the conditions of alcoholic beverages, and their slow degradation over the duration of beverage manufacture, until they disappear completely in the beverage intended for consumption,
the antioxidant effect of amphidinols in beverages, notably alcoholic beverages,
preserving the organoleptic properties of beverages, notably alcoholic beverages.

According to a particularly suitable embodiment, the product comprising at least one amphidinol used in an alcoholic beverage or in a non-alcoholic beverage comprises at least one amphidinol selected from amphidinol 1 to 19, amphidinol 22, amphidinol A and mixtures thereof.

In other words, according to a particularly suitable embodiment, the product comprising at least one amphidinol used in an alcoholic beverage or in a non-alcoholic beverage comprises at least one amphidinol selected from amphidinol 1, amphidinol 2, amphidinol 3, amphidinol 4, amphidinol 5, amphidinol 6, amphidinol 7, amphidinol 8, amphidinol 9, amphidinol 10, amphidinol 11, amphidinol 12, amphidinol 13, amphidinol 14, amphidinol 15, amphidinol 16, amphidinol 17, amphidinol 18, amphidinol 19, amphidinol 22, amphidinol A and mixtures thereof.

Preferentially, the product comprising at least one amphidinol used in an alcoholic beverage or in a non-alcoholic beverage comprises amphidinol 18.

Preferably, the product comprising at least one amphidinol is used in an alcoholic beverage or in a non-alcoholic beverage as a bactericide, yeasticide and antioxidant.

According to another suitable embodiment, the product comprising at least one amphidinol is a cell extract of one or more microalgae of the Amphidinium genus.

Advantageously, according to this embodiment, the product comprising at least one amphidinol used in an alcoholic beverage or in a non-alcoholic beverage is of natural origin.

The invention also relates to a product for use in alcoholic beverages or

in non-alcoholic beverages, comprising at least one amphidinol. According to one embodiment, the product according to the invention comprises amphidinol 18, amphidinol 19 and amphidinol 22.

Such a product is particularly useful in the context of the invention thus providing an alternative to the use of sulfites in beverages, notably alcoholic beverages.

According to another object, the invention relates to an alcoholic or non-alcoholic beverage comprising at least one amphidinol.

Finally, according to a last object, the invention relates to a method for manufacturing an alcoholic or non-alcoholic beverage comprising a step of adding at least one amphidinol to the beverage.

Further features and advantages will become apparent from the detailed description of the invention and the illustrative but non-limiting examples of the scope of the invention.

### BRIEF DESCRIPTION OF THE FIGURES

FIG. 1A is a photograph taken 3 days after incubation of three strains of Brettanomyces bruxellensis.

FIG. 1B is a graphical representation of the experimental protocol of Example 2, the aim of which is to demonstrate the effect of the product according to the invention on three strains of Brettanomyces bruxellensis.

FIG. 1C is a graphical representation of the optical density measurement over time after incubation of three strains of Brettanomyces bruxellensis in the presence of YPD medium alone (negative controls), ethanol or in the presence of a concentration of 0.06 g/L to 2 g/L of product according to the invention. Two replicas (rep1 and rep2) were made for each condition.

FIG. 2 is a photograph of an observation made using an optical microscope at ×600 magnification of the viability of Brettanomyces bruxellensis previously incubated with ethanol, the product according to the invention or an elevated temperature.

FIG. 3A is a graphical representation showing the degradability of amphidinol 18 in light and at room temperature for 120 days.

FIG. 3B is a graphical representation of Brettanomyces bruxellensis growth monitoring by measuring the optical density at 550 nm at 0, 1, 2, 3 and 7 days (T0, T1, T2, T3 and T7) after yeast incubation at 28° C. in the presence of YPD medium alone (negative control), ethanol or in the presence of a concentration of 1 g/L of product according to the invention or inactivated product according to the invention. Two replicas (rep1 and rep2) were produced.

FIG. 4 is a graphical representation of the measurement of the minimum inhibitory concentration (MIC) of the product according to the invention for different concentrations of Brettanomyces bruxellensis by monitoring the optical density.

FIG. 5A is a graphical representation showing the chromatographic data of a product according to the invention after injection into an HPLC column.

FIG. 5B is a graphical representation of a tandem mass spectrometry (MS/MS) analysis of peak 0 in FIG. 5A.

FIG. 5C is a comparative photograph of the purified fraction of peak 0 in FIG. 5A and a product according to the invention.

FIG. 5D is a graphical representation of Brettanomyces bruxellensis growth monitoring by measuring the optical density at L550 nm at 0, 3 and 6 days (T0, T3 and T6) after yeast incubation at 28° C. in the presence of YPD medium alone (−), methanol or in the presence of peak 0 at a dilution of 1/32 to 1/256 corresponding to a concentration of 40 to 5 ppm amphidinol 18 (AM18). As a positive control, substance ICC001 at 0.25 g/L was tested. Two replicas (rep1 and rep2) were produced.

FIG. 6 is a graphical representation of the minimum inhibitory concentration (MIC) measurement of the purified fraction of peak 0 on Saccharomyces cerevisiae.

FIG. 7 is a graphical representation of the measurement by monitoring the optical density of the minimum inhibitory concentration (MIC) of the purified fraction of peak 0 on Acetobacter aceti.

FIG. 8A is a graphical representation of the experimental design used in Example 9.

FIG. 8B is a graphical representation of the logarithmic measurement of the number of colony-forming units (log CFU/mL) of Brettanomyces bruxellensis NL6293 present in the wine at 1, 2, 4 and 11 days (T1, T2, T4 and T11) after inoculation of the wine with Brettanomyces bruxellensis NL6293 for the different conditions.

FIG. 8C is a graphical representation of the logarithmic measurement of the number of colony-forming units (log CFU/mL) of Brettanomyces bruxellensis NL6300 present in the wine at 1, 2, 4 and 11 days (T1, T2, T4 and T11) after inoculation of the wine with Brettanomyces bruxellensis NL6293 for the different conditions.

FIG. 8D is a graphical representation of the logarithmic measurement of the number of colony-forming units (log CFU/mL) of Saccharomyces cerevisiae present in the wine at 1, 2, 4 and 11 days (T1, T2, T4 and T11) after inoculation of the wine with Brettanomyces bruxellensis NL6293 for the different conditions.

FIG. 9A is a graphical representation of the measurement of the degradability of amphidinol 18 in wine. For each method, the amphidinol 18 content was determined in points per million (ppm) by HPLC at times T6, T16 and T44 (6 days, 16 days and 44 days after addition of a product according to the invention).

FIG. 9B is a graphical representation of the measurement of the degradability of amphidinol 18 in wine. For each method, the AM18 content is expressed as a percentage assuming that at time T0, 100% of AM18 is present in the samples.

FIG. 10 is a graphical representation of an experimental scheme for obtaining a product according to the invention in the form of a cell extract of Amphidinium carterae.

FIG. 11 is a graphical representation of a comparative study of chitosan and a product according to the invention comprising amphidinol 18 in terms of their bactericidal and yeasticidal activities.

FIG. 12 is a graphical representation showing the effect of the product according to the invention on the growth of Acetobacter Aceti in wine.

FIG. 13 is a graphical representation showing the effect of the product according to the invention on the growth of Oenococcus oenii in wine.

### DETAILED DESCRIPTION OF THE INVENTION

### Definitions

For the purposes of the invention, “beverage” refers to a liquid intended for human or animal consumption, notably so-called hot, cold, carbonated, alcoholic or non-alcoholic beverages.

For the purposes of the invention, “alcoholic beverage” refers to a beverage comprising at least 1% ethyl alcohol.

For the purposes of the invention, “non-alcoholic beverage” refers to a beverage containing less than 1% ethyl alcohol, preferentially the non-alcoholic beverage is free from ethyl alcohol.

For the purposes of the invention, “cell extract” refers to an extract obtained by lysing cells so as to release the intracellular components such as proteins, carbohydrates and metabolites. Preferentially, the metabolites present in the cell extract are amphidinols.

For the purposes of this invention, “unwanted microorganisms” refer to a bacterium, a yeast or a fungus that have more negative than positive effects on one or more beverages, particularly alcoholic beverages. In certain cases, the same microorganism within the same beverage may be considered an “unwanted microorganism” at certain concentrations and a “non-unwanted microorganism” at other concentrations or at other stages in the production of the alcoholic beverage.

For the purposes of the invention, “organoleptic qualities” refers to the sensory properties of the beverage, notably the alcoholic beverage, which are perceived by the sense organs, namely the appearance, the smell, the taste and the texture.

### Uses of a Product Comprising at Least One Amphidinol in an Alcoholic Beverage or in a Non-Alcoholic Beverage

The object of the invention is the use of a product comprising at least one amphidinol in at least one alcoholic beverage or in a non-alcoholic beverage.

Advantageously, the product comprising at least one amphidinol combats unwanted microorganisms without altering the organoleptic qualities of the beverage, notably the alcoholic beverage. The product also has an antioxidant effect in beverages, notably in alcoholic beverages.

The product comprising at least one amphidinol can therefore be used according to the invention in a beverage, notably in an alcoholic beverage specifically as a sulfite substitute.

“Product comprising at least one amphidinol” refers to any product in any form comprising one or more amphidinol molecule(s) and optionally one or more other elements such as notably excipients or another active molecule. According to one embodiment, the product comprising at least one amphidinol consists solely of one or more amphidinol molecules.

The invention therefore also covers the use of at least one amphidinol to combat at least one unwanted microorganism present in an alcoholic beverage or in a non-alcoholic beverage. In particular, one object of the invention is the use of at least one amphidinol in an alcoholic beverage or in a non-alcoholic beverage, to control and/or limit the growth of at least one unwanted microorganism.

Preferably, the product comprising at least one amphidinol used in an alcoholic beverage or in a non-alcoholic beverage comprises at least one amphidinol selected from amphidinol 1 to 19, amphidinol 22, amphidinol A and mixtures thereof.

Preferentially, the product comprising at least one amphidinol used in an alcoholic beverage or in a non-alcoholic beverage comprises at least one amphidinol selected from amphidinol 3, amphidinol 18, amphidinol 19, amphidinol 22, amphidinol A and mixtures thereof.

Preferentially, the invention relates to the use of at least one amphidinol selected from amphidinol 1 to 19, amphidinol 22 and combinations thereof, to combat at least one undesirable micro-organism present in an alcoholic beverage or a non-alcoholic beverage. According to a particularly suitable embodiment, the invention is aimed at the use of amphidinol 18 to combat at least one unwanted microorganism present in an alcoholic beverage or in a non-alcoholic beverage.

According to one embodiment, the object of the invention is the use of a product comprising at least amphidinol 18 in an alcoholic beverage or in a non-alcoholic beverage.

Preferentially, the product comprising at least one amphidinol used in an alcoholic beverage or in a non-alcoholic beverage comprises at least amphidinol 18 and amphidinol 3.

According to one embodiment, the product comprising at least one amphidinol used in an alcoholic beverage or in a non-alcoholic beverage comprises at least amphidinol 18 and amphidinol 22.

According to a particular embodiment of the invention, the product comprising at least one amphidinol used in an alcoholic beverage or in a non-alcoholic beverage comprises amphidinol 18, amphidinol 19 and amphidinol 22.

Preferentially, the product comprising at least one amphidinol used in an alcoholic beverage or in a non-alcoholic beverage comprises at least amphidinol 18 and at least one amphidinol selected from amphidinol 1 to 17, amphidinol 19 to 22, amphidinol A and mixtures thereof.

The product comprising at least one amphidinol used in a beverage, notably an alcoholic beverage can be specifically a product according to the invention as described in the present application.

Preferentially, the product comprising at least one amphidinol used according to the invention in an alcoholic beverage or in a non-alcoholic beverage is of natural origin. Preferably, the product comprising at least one amphidinol used in an alcoholic beverage or in a non-alcoholic beverage is obtained from a cell extract of one or more microalgae of the Amphidinium genus.

Preferentially, the product comprising at least one amphidinol used in an alcoholic beverage or in a non-alcoholic beverage is a cell extract of one or more microalgae of the Amphidinium genus.

In one embodiment, said microalgae of the Amphidinium genus is selected from the following species: Amphidinium carterae or Amphidinium klebsii.

In a particularly preferred embodiment, the product comprising at least one amphidinol used in an alcoholic beverage or in a non-alcoholic beverage is or comprises a cell extract of Amphidinium carterae.

In one embodiment, the product comprising at least one amphidinol used in an alcoholic beverage or in a non-alcoholic beverage is or comprises a cell extract of an Amphidinium carterae strain selected from the group consisting of CCMP 124, CCMP 1314, CCMP 3177, AC 208, AC 792, and BEA 01198. In the context of the invention, CCMP means “Culture Collection of Marine Phytoplankton”, AC means “Algobank Caen” and BEA means “Banco Espanol de Algas” [Spanish Bank of Algae].

Preferably, the product comprising at least one amphidinol used in an alcoholic beverage or in a non-alcoholic beverage is or comprises a cell extract of an Amphidinium carterae strain selected from the group consisting of CCMP 1314, AC 208 and AC 792.

When the product comprising at least one amphidinol used in an alcoholic beverage or in a non-alcoholic beverage is or comprises a cell extract of one or more microalgae of the Amphidinium genus, said extract may be prepared by any cell extraction method known to a person skilled in the art, solid-liquid, liquid-liquid or gas-liquid, for example inorganic or organic solvent extraction, which may be selected from the group consisting of water, aqueous solutions, ketones, esters, acids, ethers, alcohols and mixtures in any miscible proportions of these solvents.

According to one variant, when the product comprising at least one amphidinol used in an alcoholic beverage or in a non-alcoholic beverage is or comprises a cell extract of one or more microalgae of the Amphidinium genus, said extract can be prepared by supercritical CO2/H2O extraction.

According to one embodiment, the product comprising at least one amphidinol used in an alcoholic beverage or in a non-alcoholic beverage is or comprises a cell extract of one or more microalgae of the Amphidinium genus, said extract being obtained by extraction in an alcohol, preferentially in an alcohol comprising between 1 and 4 carbon atoms, even more preferentially methanol or ethanol.

Preferably, when the product comprising at least one amphidinol used in an alcoholic beverage or in a non-alcoholic beverage is or comprises a cell extract of one or more microalgae of the Amphidinium genus, said extract is a water-soluble fraction.

In one embodiment, the invention is aimed at the use of a product comprising at least one amphidinol, preferentially at least amphidinol 18, in an alcoholic beverage or in a non-alcoholic beverage, at a concentration greater than 1% by weight with respect to the total weight of the product, preferentially between 1% and 100% by weight with respect to the total weight of the product, notably between 50% and 90% by weight with respect to the total weight of the product, even more preferentially between 75% and 90% by weight with respect to the total weight of the product.

In one embodiment, the invention is aimed at the use of a product comprising at least one amphidinol, preferentially at least amphidinol 18, in an alcoholic beverage or in a non-alcoholic beverage, at a concentration of between 1 and 50 g/L, preferably between 5 and 40 g/L, preferably between 20 and 50 g/L, preferably 33 g/L.

In one embodiment, the invention is aimed at the use of a product comprising at least one amphidinol, preferentially at least amphidinol 18, in an alcoholic beverage or in a non-alcoholic beverage, at a concentration between 0.06 g/L and 10 g/L with respect to the total volume of said beverage, preferentially between 0.06 and 5 g/L, between 0.06 and 2 g/L, between 0.06 and 1 g/L, between 0.06 and 0.5 g/L, between 0.06 and 0.25 g/L with respect to the total volume of said beverage. According to one embodiment, the product comprising at least one amphidinol used in an alcoholic beverage or in a non-alcoholic beverage is present in said beverage at a concentration of about 0.125 g/L, with respect to the total volume of said beverage.

Preferentially, the product comprising at least one amphidinol used in an alcoholic beverage or in a non-alcoholic beverage according to the invention does not comprise at least one of the molecules selected from lingshuiols, karatungiols, luteophanols and colopsinols.

According to a suitable variant, the product comprising at least one amphidinol used in an alcoholic beverage or in a non-alcoholic beverage according to the invention, does not comprise at least one molecule selected from carteraol E, amphezonol A and mixtures thereof.

Preferably, the product comprising at least one amphidinol used in an alcoholic beverage or in a non-alcoholic beverage according to the invention does not comprise carteraol.

The product comprising at least one amphidinol can be used in any type of alcoholic beverage, preferentially the beverages obtained by alcoholic fermentation.

According to a preferred embodiment, the alcoholic beverage is selected from wine, cider and beer.

In a particularly preferred embodiment, the alcoholic beverage is a red wine.

According to another embodiment, the product according to the invention can be used in any type of non-alcoholic beverage, preferentially non-alcoholic beverages obtained by fermentation.

According to a preferred embodiment, the non-alcoholic beverage is a fruit juice, preferably a grape juice, an apple juice or a fruit blend.

Advantageously, the use of a product comprising at least one amphidinol in a beverage, notably an alcoholic beverage, makes it possible to:
control and/or limit the growth of unwanted microorganisms
have an antioxidant effect and to fight free radicals
preserve the organoleptic qualities of the beverage.

Preferentially, the product comprising at least one amphidinol is used according to the invention in an alcoholic beverage or in a non-alcoholic beverage having a pH of less than 7, preferentially less than 4.

Preferentially, the product comprising at least one amphidinol is used according to the invention in an alcoholic beverage having at least 1% ethyl alcohol, notably at least 4%, even more preferentially at least 12%.

According to one variant of the invention, the product comprising at least one amphidinol can be used in a non-alcoholic beverage.

Preferentially, the product comprising at least one amphidinol is used in an alcoholic beverage or in a non-alcoholic beverage as:
yeasticide, notably for controlling and/or limiting the growth of yeasts belonging to at least one genus Brettanomyces, Hansenula, Saccharomyces, Hanseniaspora, Pichia, Candida, Kloeckera, Torulopsis, Schizosaccharomyces and combinations thereof, even more preferentially for controlling and/or limiting the growth of yeasts belonging to the genus Brettanomyces, notably for controlling and/or limiting the growth of yeasts belonging to the species Brettanomyces bruxellensis, and/or
bactericide, even more preferentially to control and/or limit the growth of bacteria belonging to the genus selected from Gluconobacter, Acetobacter, Oenococcus, Lactobacillus, Pediococcus, Pectinatus, Megasphaera, Citrobacter, Enterobacter, Obesumbacterium, Klebsiella, Proteus, Serratia, Zymomonas, notably to control and/or limit the growth of bacteria belonging to the species Acetobacter aceti, and/or
antioxidant.

Preferably, the product comprising at least one amphidinol is used in an alcoholic beverage, preferentially in wine, as a bactericide, yeasticide and antioxidant.

According to another embodiment, the product comprising at least one amphidinol is used in a non-alcoholic beverage, preferentially in a fruit juice, as a bactericide, yeasticide and antioxidant.

According to one embodiment, the invention relates to the use of at least one amphidinol to combat at least one unwanted microorganism in an alcoholic beverage, preferentially selected from alcoholic beverages obtained by alcoholic fermentation, notably wine, cider and beer.

According to one embodiment, the product comprising at least one amphidinol is used in an alcoholic beverage or in a non-alcoholic beverage as a yeasticide to control and/or limit the growth of at least one yeast of a genus selected from Brettanomyces, Hansenula, Saccharomyces, Hanseniaspora, Pichia, Candida, Kloeckera, Torulopsis, Schizosaccharomyces and combinations thereof.

Advantageously, the product comprising at least one amphidinol used in an alcoholic beverage or in a non-alcoholic beverage prevents a yeast of the aforementioned genus from becoming the majority in an alcoholic beverage, and as a result, prevents the production of unwanted metabolites whose formation in large numbers can induce undesirable tastes in a beverage, notably an alcoholic beverage. Preferably, the product comprising at least one amphidinol is used in an alcoholic beverage or in a non-alcoholic beverage as a yeasticide to control and/or limit the growth of at least one yeast species selected from Kloeckera apiculata, Brettanomyces bruxellensis, Saccharomyces cerevisiae, Pichia membranifaciens, Hansenula anomala and combinations thereof.

According to another embodiment, the product comprising at least one amphidinol is used in an alcoholic beverage or in a non-alcoholic beverage as a bactericide to control and/or limit the growth of at least one bacterium of a genus selected from Gluconobacter, Acetobacter, Oenococcus, Lactobacillus, Pediococcus, Pectinatus, Megasphaera, Citrobacter, Enterobacter, Obesumbacterium, Klebsiella, Proteus, Serratia, Zymomonas.

Advantageously, the product comprising at least one amphidinol used in an alcoholic beverage or in a non-alcoholic beverage prevents a bacterium of the aforementioned genus from becoming the majority in an alcoholic beverage or in a non-alcoholic beverage, and as a result, prevents the production of unwanted metabolites whose formation in large numbers can induce undesirable tastes in an alcoholic beverage.

Preferably, the product comprising at least one amphidinol is used in an alcoholic beverage as a bactericide to control and/or limit the growth of at least one bacterial species selected from Oenococcus oenii, Lactobacillus brevis, Lactobacillus plantarum, Pediococcus damnosus, Pediococcus inopinatus, Pediococcus pentosaceus, Enterobacter cloaceae, Enterobacter agglomerans, Citrobacter freundii, Obesumbacterium proteus, Zymomonas mobilis and combinations thereof.

According to one embodiment, the product comprising at least one amphidinol is used in wine, preferentially in red wine, at least as a yeasticide.

Preferentially, the product comprising at least one amphidinol is used in wine to control and/or limit the growth of at least one yeast of a genus selected from Brettanomyces, Hansenula, Saccharomyces, Hanseniaspora, Pichia, Candida, Kloeckera and combinations thereof.

Preferably, the product comprising at least one amphidinol is used in wine to control and/or limit the growth of at least one yeast species selected from Kloeckera apiculata, Brettanomyces bruxellensis, Saccharomyces cerevisiae and combinations thereof.

Particularly preferably, the product comprising at least one amphidinol is used in wine to control and/or limit the growth of Brettanomyces bruxellensis.

In a particular embodiment of the invention, the product comprising at least one amphidinol is used in wine to control and/or limit the growth of at least one undesirable yeast of the species Brettanomyces bruxellensis and strain(s) NL6295, NL6300 and/or NL6293 (these strains being strains that have been isolated from contaminated wine).

Thus, according to one variant, the invention relates to the use of at least one amphidinol in a wine to combat at least one unwanted yeast selected from yeasts of the Brettanomyces genus (notably Brettanomyces bruxellensis), Candida genus (notably Candida stellata, Candida pulcherrima or Candida vini), Hansenula (notably Hansenula anomala), Hanseniaspora, Kloeckera (notably Kloeckera apiculata), Pichia (notably Pichia membranifaciens), Zygosaccharomyces and Saccharomyces (within this last genus, only certain wild strains of Saccharomyces cerevisiae: var. diastaticus, pastorianus, ellipsoideus and willianus can be considered to be unwanted yeasts). Preferentially, the invention relates to the use of at least one amphidinol in a wine to combat Brettanomyces bruxellensis yeast, preferably Brettanomyces bruxellensis yeast of strain NL6295, NL6300 or NL6293.

In one embodiment, the invention relates to the use of at least one amphidinol in a wine to control at least one bacterium selected from unwanted acetic bacteria and unwanted lactic acid bacteria.

According to one embodiment, the invention also relates to the use of a product comprising at least one amphidinol in wine as a bactericide.

Preferentially, the product comprising at least one amphidinol is used according to the invention in wine to control and/or limit the growth of at least one bacterium selected from bacteria of the genus Gluconobacter, Acetobacter, Oenococcus, Lactobacillus, Pediococcus and combinations thereof.

Preferably, the product comprising at least one amphidinol is used in wine to control and/or limit the growth of Oenococcus oenii.

In one embodiment, the alcoholic beverage is a wine, and the at least one unwanted microorganism is at least:
an acetic bacterium selected from bacteria of the genus Acetobacter (notably Acetobacter aceti) and Gluconobacter and/or
a lactic acid bacterium selected from bacteria of the genus Oenococcus (notably Oenococcus oenii), Lactobacillus and Pediococcus.

According to one embodiment, the product comprising at least one amphidinol is used in beer as a yeasticide.

Preferentially, the product comprising at least one amphidinol is used in beer to control and/or limit the growth of at least one yeast genus selected from Torulopsis, Schizosaccharomyces, Brettanomyces, Hansenula, Rhodotorula, Saccharomyces, Pichia, Candida, Kloeckera and combinations thereof.

Preferably, the product comprising at least one amphidinol is used in beer to control and/or limit the growth of at least one yeast species selected from Pichia membranifaciens, Hansenula anomala, Saccharomyces cerevisiae and combinations thereof.

Particularly preferably, the product comprising at least one amphidinol is used in beer to control and/or limit the growth of Brettanomyces bruxellensis.

In one embodiment, the invention relates to the use of at least one amphidinol in a beer to control at least one unwanted yeast selected from the yeasts of the Brettanomyces, Candida (notably Candida Rhodotorula), Hansenula (notably Hansenula anomala), Kloeckera, Pichia (notably Pichia membranifaciens) and Saccharomyces genera (within this last genus, only certain wild strains of Saccharomyces cerevisiae: var. diastaticus, pastorianus, ellipsoideus and willianus, can be considered to be unwanted yeasts).

According to one embodiment, the product comprising at least one amphidinol is used in beer as a bactericide.

Preferentially, the product comprising at least one amphidinol is used in beer to control and/or limit the growth of at least one genus of bacteria selected from Gluconobacter, Pectinatus, Megasphaera, Acetobacter, Lactobacillus, Pediococcus, Citrobacter, Enterobacter, Obesumbacterium, Klebsiella, Proteus, Serratia, Zymomonas and combinations thereof.

Preferably, the product comprising at least one amphidinol is used in beer to control and/or limit the growth of at least one bacterial species selected from Lactobacillus brevis, Lactobacillus plantarum, Pediococcus damnosus, Pediococcus inopinatus, Pediococcus pentosaceus, Enterobacter cloaceae, Enterobacter agglomerans, Citrobacter freundii, Obesumbacterium proteus, Zymomonas mobilis.

In one embodiment, the invention relates to the use of at least one amphidinol in a beer to combat at least one undesirable bacterium selected from bacteria of the genus Acetobacter, Citrobacter (notably Citrobacter freundii), Enterobacter (notably Enterobacter cloaceae or Enterobacter agglomerans), Gluconobacter, Lactobacillus (notably Lactobacillus brevis or Lactobacillus plantarum), Megasphaera, Obesumbacterium (notably Obesumbacterium proteus), Pectinatus, Pediococcus (notably Pediococcus inopinatus or Pediococcus pentosaceus), Zymomonas (notably Zymomonas mobilis), Klebsiella, Proteus, Serratia, Hafnia, Selenomonas (notably Selenomonas lacticifex) and Zymophilus.

According to one embodiment, the product comprising at least one amphidinol used in an alcoholic beverage is in powder form or in liquid form.

In contrast to the solutions proposed by the background art, and to other bactericides and/or yeasticides, the use of a product comprising at least one amphidinol is suitable for beverages intended for consumption and can be used in an alcoholic beverage having a pH of less than 7, preferably less than 4, without being rapidly degraded.

Advantageously, the product comprising at least one amphidinol used in an alcoholic beverage retains its properties at acid pH, notably its ability to control and/or limit the growth of yeasts belonging to the Brettanomyces genus.

Preferentially, the product comprising at least one amphidinol used in an alcoholic beverage, in particular wine, is degraded by at least 40% by weight of the total weight of the product within 144 hours in said beverage.

Advantageously, amphidinols, more particularly amphidinols 18, 19 and 22, degrade naturally over time in the alcoholic beverage. Thus, unlike sulfites, a high concentration of amphidinol can be introduced into the alcoholic beverage to combat undesirable microorganisms without being ingested by the consumer.

A person skilled in the art is capable of calculating an initial concentration required to combat unwanted microorganisms while measuring the degradation of amphidinols over time to limit their ingestion by the consumer.

In wine, with a concentration of 60 to 480 ppm, it is 90% degraded in 44 days.

Advantageously, the product comprising at least one amphidinol used in an alcoholic beverage mixes to form a homogeneous alcoholic beverage.

In one embodiment, the invention relates to the use of at least one amphidinol in a fruit juice to combat Saccharomyces cerevisiae.

### Product for Use in Alcoholic Beverages or in Non-Alcoholic Beverages, Comprising at Least One Amphidinol

The invention also relates to a solid product for use in alcoholic beverages or in non-alcoholic beverages, comprising at least one amphidinol.

Such a product is particularly useful in the context of the invention thus making it possible to combat unwanted microorganisms such as yeasts and/or bacteria present in alcoholic beverages or in non-alcoholic beverages, while having no impact on the organoleptic characteristics of said beverages.

According to a preferred embodiment, the product according to the invention comprises at least one amphidinol selected from amphidinol 1 to 19, amphidinol 22, amphidinol A and mixtures thereof.

Preferentially, the product according to the invention comprises at least one amphidinol selected from amphidinol 18, amphidinol 19, amphidinol 22 and mixtures thereof.

Preferentially, the product according to the invention comprises at least two amphidinols selected from amphidinol 1 to 19, amphidinol 22, amphidinol A and mixtures thereof.

Preferentially, the product according to the invention comprises at least two amphidinols selected from amphidinol 18, amphidinol 19, amphidinol 22 and mixtures thereof.

According to one embodiment, the product according to the invention comprises amphidinol 18 and at least one amphidinol selected from amphidinol 1 to 17, amphidinol 19 to 22, amphidinol A and mixtures thereof.

Preferentially, the product according to the invention comprises at least one amphidinol selected from amphidinol 18 and/or amphidinol 22.

Preferentially, the product according to the invention comprises at least one amphidinol selected from amphidinol 18 and/or amphidinol 3.

According to another preferred embodiment, the product according to the invention comprises at least amphidinol 18, amphidinol 19 and amphidinol 22.

Advantageously, the yeasticidal and/or bactericidal and/or antioxidant activity, more particularly the control of the growth of yeasts belonging to the Brettanomyces genus, is due solely to the amphidinols present in the product according to the invention.

According to one particular embodiment, the product according to the invention comprises at least 50% amphidinol 18 and at least one amphidinol selected from amphidinol 1 to 17, amphidinol 19 to 22, amphidinol A and mixtures thereof.

Preferentially the product according to the invention comprises by weight of the total weight of the product:
between 40 and 60% of amphidinol 18,
between 35 and 45% of amphidinol 19, and/or
between 35 and 45% of amphidinol 22.

The product according to the invention is particularly suitable for use in beverages, preferably in alcoholic beverages.

According to one embodiment, the product according to the invention is in powder form or in liquid form.

Preferably, the product according to the invention is obtained from a cell extract of one or more microalgae of the Amphidinium genus.

The product according to the invention is preferentially a cell extract of one or more microalgae of the Amphidinium genus.

Said microalgae of the Amphidinium genus may notably belong to the Amphidinium carterae species.

When the product according to the invention is a cell extract of one or more microalgae of the Amphidinium genus, said extract can be prepared by any cell extraction method known to a person skilled in the art, solid-liquid or liquid-liquid, for example an inorganic or organic solvent extraction, which can be selected from the group consisting of water, aqueous solutions, ketones, esters, acids, ethers, alcohols and mixtures in any miscible proportions of these solvents.

According to one embodiment, the product comprising at least one amphidinol is a cell extract of one or more microalgae of the Amphidinium genus, said extract being obtained by extraction in an alcohol, preferentially in an alcohol comprising between 1 and 4 carbon atoms, even more preferentially methanol or ethanol.

Preferably, when the product comprising at least one amphidinol is a cell extract of one or more microalgae of the Amphidinium genus, said extract is a water-soluble fraction.

When the product according to the invention is a cell extract of one or more microalgae of the Amphidinium genus, the preparation method thereof is characterized by the following steps:
a) harvesting fresh cells from one or more microalgae of the Amphidinium genus;
a′) optionally freezing and/or lyophilizing said cells;
b) suspending said fresh or frozen cells or said lyophilisate in an inorganic or organic solvent in a lyophilisate or biomass/solvent weight ratio of between 1:200 and 1:2;
b′) optionally lyophilizing the extract obtained.

Preferably, the inorganic solvent can be selected from water or aqueous solutions. Preferentially, the organic solvent of step b) can be selected from:
hydrocarbon solvents such as aliphatics or aromatics;
oxygenated solvents such as alcohols, ketones, acids, esters and ethers; and
mixtures of these solvents in any miscible proportions.

According to a preferred embodiment, the organic solvent in step b) is an alcohol having 1 to 4 carbon atoms, such as methanol or ethanol.

When the solvent in step b) is an organic solvent, suspension can be carried out at a temperature of between 4 and 60° C., preferably between 18 and 60° C., and particularly preferably at room temperature.

Preferably, the suspension in step b) of said fresh or frozen cells or said lyophilisate in an inorganic solvent is carried out at room temperature. Preferably, the suspension in step b) of said fresh or frozen cells or said lyophilisate in an inorganic solvent lasts less than 5 minutes, preferably less than 3 minutes, more preferably less than 1 minute.

The suspension in step b) is carried out either by adding to said fresh or frozen cells or to said lyophilisate the solvent previously brought to the desired temperature, or by adding the solvent, resuspending the mixture and adjusting to the desired temperature.

Preferably, the suspension in step b) of said fresh or frozen cells or said lyophilisate in an inorganic or organic solvent is carried out in a lyophilisate or biomass/solvent weight ratio of between 1:100 and 1:50.

Advantageously, the fresh cells harvested and extracted in step a) come from a cell culture under temperature, photoperiod and salinity conditions adapted to the strain concerned up to a cell concentration of between 5·104 cells/mL and 5·107 cells/mL, preferentially a cell concentration of between 5·105 cells/mL and 2·107 cells/mL. The cells are batch cultured for 5 to 20 days, then continuously or semi-continuously cultured for several months. The light intensity is between 40 μE and 2000 μE, preferably between 70 μE and 500 μE. The culture temperature is generally between 17° C. and 30° C., preferably between 17° C. and 26° C. The day/night photoperiod is preferably between 8 h/16 h and 16 h/8 h. The minimum salinity is 15 ppt (parts per thousand).

According to a particular embodiment, when the fresh cells harvested and extracted in step a) come from the Amphidinium carterae strain, they have been cultured according to the following parameters: the cells are incubated in natural or artificial seawater medium at a temperature of between 17 and 25° C. with a day/night cycle of between 8 h/16 h and 16 h/8 h, preferably 16 h/8 h.

### Alcoholic or Non-Alcoholic Beverage Comprising at Least One Amphidinol

The invention also relates to a key developmental intermediate for obtaining an alcoholic beverage or a non-alcoholic beverage without added sulfites, without unwanted microorganisms and without any adverse effect on flavor.

To this end, the invention relates to an alcoholic or non-alcoholic beverage comprising at least one amphidinol. This beverage comprising at least one amphidinol is a beverage undergoing aging, during which phase the amphidinol or amphidinols introduced according to the invention are still present.

The presence of at least one amphidinol is temporary in the alcoholic beverage due to the degradability of amphidinols.

According to one embodiment, the alcoholic or non-alcoholic beverage according to the invention comprises at least one amphidinol selected from amphidinol 1 to 19, amphidinol 22, amphidinol A and mixtures thereof.

According to a preferred embodiment, the alcoholic or non-alcoholic beverage according to the invention comprises at least one amphidinol selected from amphidinol 18, amphidinol 19, amphidinol 22 and mixtures thereof.

According to a particular embodiment, the alcoholic or non-alcoholic beverage according to the invention comprises at least two amphidinols selected from amphidinol 1 to 19, amphidinol 22, amphidinol A and mixtures thereof.

Preferentially, the alcoholic or non-alcoholic beverage according to the invention comprises amphidinol 18 and at least one amphidinol selected from amphidinol 1 to 17, amphidinol 19 to 22, amphidinol A and mixtures thereof.

Preferentially, the alcoholic or non-alcoholic beverage according to the invention comprises at least one amphidinol selected from amphidinol 18, amphidinol 22 and mixtures thereof.

Preferentially, the alcoholic or non-alcoholic beverage according to the invention comprises at least one amphidinol selected from amphidinol 18, amphidinol 3 and mixtures thereof.

According to a preferred embodiment, the alcoholic or non-alcoholic beverage according to the invention comprises a product described according to any one of the previously described embodiments.

The alcoholic or non-alcoholic beverage according to the invention does not contain added sulfites.

Method for manufacturing an alcoholic or non-alcoholic beverage

According to a final object, the invention relates to a method for manufacturing an alcoholic or non-alcoholic beverage comprising the implementation of a step of adding at least one amphidinol to the beverage.

According to a particular embodiment of the invention, the addition of at least one amphidinol to the alcoholic or non-alcoholic beverage can be carried out at any time during the method of preparing an alcoholic or non-alcoholic beverage.

According to a preferred embodiment, the method for manufacturing an alcoholic or non-alcoholic beverage according to the invention comprises at least one step of adding at least one product described according to any one of the previously described embodiments.

Preferably, the alcoholic beverage according to the invention can be any beverage obtained by alcoholic fermentation. Preferentially, the alcoholic beverage according to the invention can be selected from wine, preferentially red wine, whiskey, cider, beer and kombucha.

According to another embodiment, the non-alcoholic beverage according to the invention is a fruit juice.

According to one embodiment, the alcoholic or non-alcoholic beverage is opaque.

### EXAMPLES

### Example 1: Obtaining a Product According to the Invention in the Form of an Extract of the Microalgae Amphidinium carterae

Laboratory culture of the microalgae Amphidinium carterae, strain ICC001, is carried out in ventilated T25, T50 flasks or 5 L flasks in L1 medium (see medium composition below) in an 18° C. culture chamber with a 12 h/12 h day/night cycle at a light intensity of 50-100 μE.

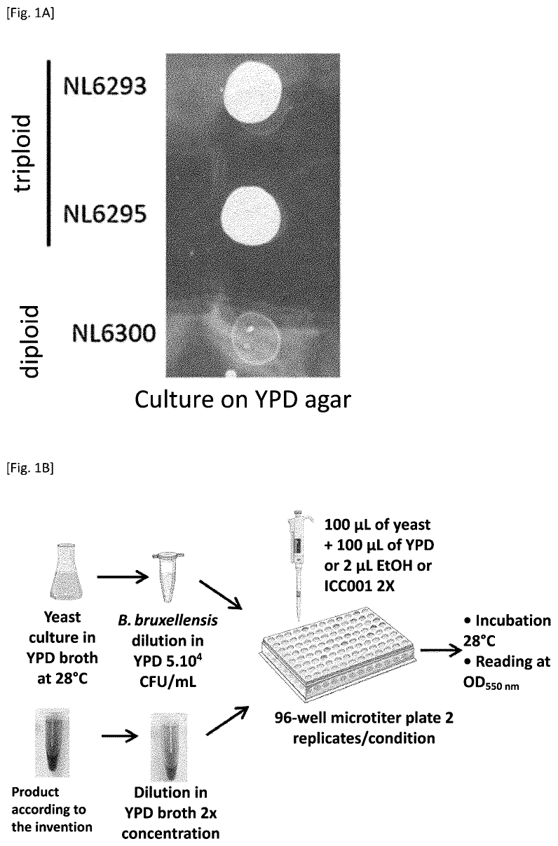

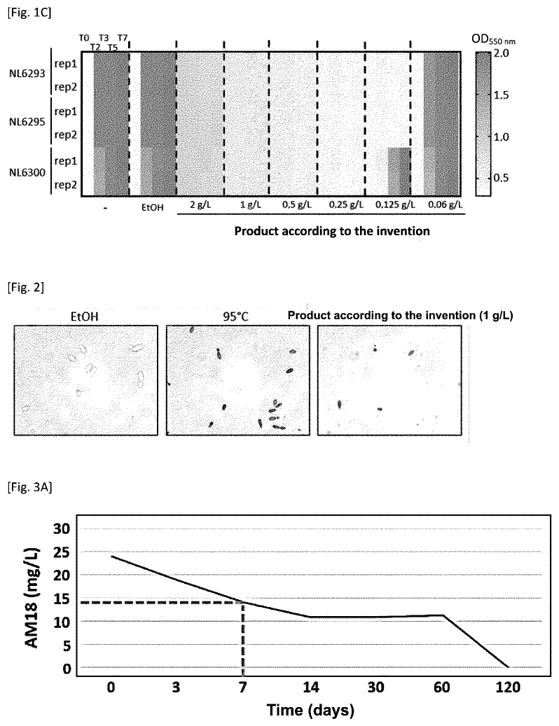

Scaling up culture volumes makes it possible to move from less than one liter of culture to several m3 and requires the use of photobioreactors (PBRs) containing culture bags. This is achieved by inoculating 100 L bags of PBR culture medium with 5 L cultures of the microalgae. PBR culture is carried out at a temperature of 22-23° C. with pH control by adding CO2 and bubbling (aeration flow rate of 1 L/min). Illumination at 6500 K is between 150 and 500 μE in continuous light over 24 hours. Once the culture has reached the desired optical density, the microalgae are harvested on a continuous basis by taking daily samples of 10-20% of the culture and adding an equivalent volume of culture medium. These microalgae samples are collected using a tangential filtration system to concentrate the microalgae which are then centrifuged to obtain a microalgae paste with a dry matter content of 25-35%. This paste is then resuspended in 100% ethanol (EtOH) in order to obtain a final EtOH concentration of 60-70%. A content of 100 g of dry matter per 1 L of solution (100 g/L) is thus obtained. This extract is centrifuged at 5000 rpm to obtain a clarified supernatant which corresponds to the product according to the invention and which theoretically contains 100 g/L dry matter. The product according to the invention has an amphidinol 18 concentration of 33 g/L. This product according to the invention will be diluted in 100% EtOH at various concentrations from 0.006 g/L to 2 g/L and used for FIGS. 1 to 4 and for FIGS. 9A, 9B, 12 and 13.

The product according to the invention was then purified by reverse-phase exclusion chromatography on a C18 column in order to obtain an elution peak containing amphidinol 18 (AM18), referred to as peak 0. This peak 0 was used for FIGS. 5 to 8. To do this, the paste was resuspended in methanol (MetOH) at 3 mg dry matter to 1 mL MetOH. After filtering this paste to 0.2 μm, 10 μL of the sample was injected into the C18 column. Elution of the various components was carried out using a mixture of solvent A (0.1% formic acid) and solvent B (MetOH) which differed according to elution time: T0 min (A/B: 50/50); T25 min (A/B: 0/100); T40 min (A/B: 0/100); T43 min (A/B: 50/50) and T48 min (A/B: 50/50). Peak 0 corresponds to the first elution peak and for which the presence of AM18 (molecular weight: 1381.8 Da and molar mass: 1358.83 g/mol) was confirmed by mass spectrometry.

Peak 0 was used in FIGS. 5, 6, 7 and 8. It is sometimes referred to as the “peak 0 purified fraction”.

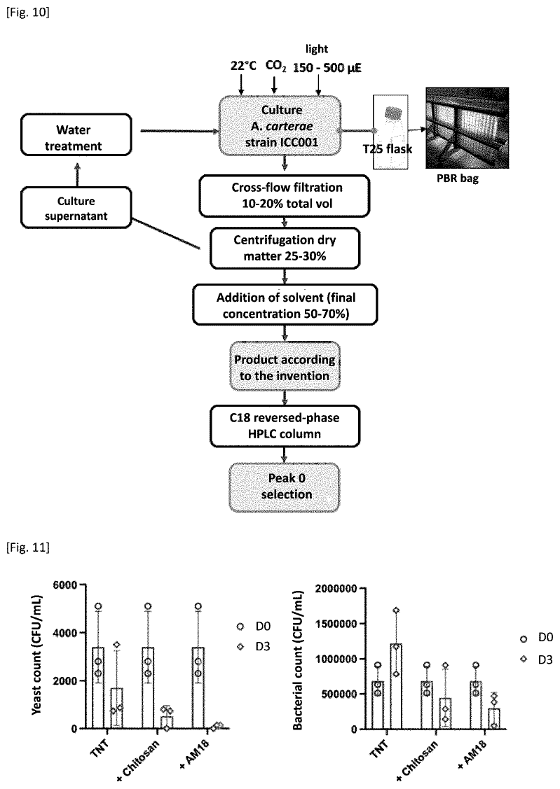

The general diagram of the method is given in FIG. 10.
Composition of 1 L of L1 medium
1 L of SSW medium
2 mL of NP solution
1 mL of metal solution
0.5 mL of F/2 vitamins.
SSW solution:
NaCl: 24.5 g
Na2SO4: 4.09 g
KCl: 0.7 g
NaHCO₃: 0.2 g
KBr: 0.1 g
H3BO3: 0.03 g
NaF: 0.003 g
MgCl2 6H2O: 11.1 g
CaCl2 2H2O: 1.54 g
H20 qsp 1 L
NP solution (50×):
NaNO3: 37.5 g
NaH2PO₄-H2O: 2.5 g
H2O: qsp 100 mL.
Metal solution (1000×):
FeCl3·6H2O: 3.15 g
Na2EDTA·2H2O: 4.36 g
CuSO4·5H2O: 0.00245 g
Na2MoO4·2H2O: 0.0189 g
ZnSO4·7H2O: 0.022 g
CoCl2·6H2O: 0.01 g
MnCl2·4H2O: 0.18 g
H2SeO3: 0.0013 g
NiSO4·6H2O: 0.0027 g
Na3VO4: 0.00184 g
K2CrO4: 0.00194 g
H20: qsp 1 L.
F/2 vitamins solution:
Thiamine (B1): 400 mg
Cobalamin (B12): 2 mg
Biotin (H): 2 mg
H20: qsp 1 L

### Example 2: Demonstration of the Effect of a Product According to the Invention on Three Strains of Brettanomyces Bruxellensis

Three strains of Brettanomyces bruxellensis, and more specifically two triploid strains (NL6293 and NL6293) and one diploid strain (NL6300), were grown independently on YPD agar medium in petri dishes.

After three days of incubation at 28° C. and at atmospheric pressure, a photo revealing the presence of the three colonies was taken, and is shown in FIG. 1A.

Then, dilutions of these three strains are prepared at 5·104 CFU/mL.

Moreover, dilutions of the product according to the invention are also made in YPD.

The three strains were then incubated in the presence or absence of the product according to the invention at different concentrations for seven days at 28° C. and at atmospheric pressure.

The various samples are as follows:
YPD alone (negative control; 100 μL of yeast dilution+100 μL of YPD);
YPD in the presence of ethanol (100 μL of yeast dilution+100 μL of YPD containing 0.7 μL of ethanol);
YPD with presence of product according to the invention (100 μL of yeast dilution+100 μL of YPD containing 0.06 g/L to 2 g/L of product according to the invention).

Two replicas were made for each condition.

A general outline of this protocol is given in FIG. 1B.

Yeast growth is measured by reading the optical density at 550 nanometers at the following times: T=0, T=2 days, T=3 days, T=5 days, and T=7 days.

The summary of the optical densities measured is given in FIG. 1C.

It should be noted that the populations of the three strains of Brettanomyces bruxellensis are particularly sensitive to ICC001, and in particular when the concentration of the product according to the invention is 0.250 g/L.

It has therefore been demonstrated that the product according to the invention has an antimicrobial activity against various strains of Brettanomyces bruxellensis.

Furthermore, if we compare the activity of the product according to the invention with that of ethanol, it turns out to be better, whatever the concentration tested.

### Example 3: Demonstration of the Effect of the Product According to the Invention on the Viability of Brettanomyces Bruxellensis

A strain NL6293 of Brettanomyces bruxellensis was, according to the samples:
previously incubated in the presence of 1:300 ethanol for twenty-four hours;
previously incubated in the presence of 1 g/L of product according to the invention for twenty-four hours; or else
subjected to a temperature of 95° C. for five minutes.

Next, all samples were incubated for one minute with trypan blue, which is a cell viability marker (it is excluded from viable cells but is present in non-viable cells and marks the nucleus) acting as a DNA intercalating agent.

Next, a photo was taken of each of the three samples. This is given in FIG. 2.

It has therefore been demonstrated that the product according to the invention causes a loss of viability of Brettanomyces bruxellensis.

Moreover, if we compare the activity of the product according to the invention with that of ethanol, it turns out to be better.

### Example 4: Demonstration of the Effect of Amphidinol 18 on Three Strains of Brettanomyces Bruxellensis

A product according to the invention at one gram per liter (in 70% ethanol) was placed in the light and at room temperature for 120 days.

Regularly, the concentration of amphidinol 18 in the product according to the invention has been measured by high-performance liquid chromatography.

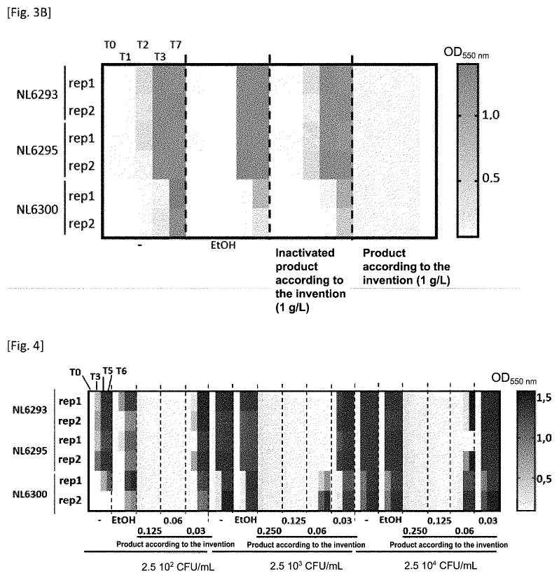

All the data collected has been plotted on a graph, given in FIG. 3A.

It was shown that the amphidinol 18 concentration of the product according to the invention decreased; at T=0 days, it was 24 mg/L, while at T=120 days, it was close to 0 mg/L.

In parallel, different samples were prepared using the same three strains of Brettanomyces bruxellensis as in Example 2:
YPD alone (negative control; 100 μL of yeast dilution+100 μL of YPD);
YPD in the presence of ethanol (100 μL of yeast dilution+100 μL of YPD containing 0.7 μL of ethanol);
YPD in the presence of the product according to the invention (100 μL of yeast dilution+100 μL of YPD containing 1 g/L of product according to the invention; T=0 days);
YPD in the presence of inactivated product according to the invention (100 μL of yeast dilution+100 μL of YPD containing 1 g/L of product according to the invention with an aging degree of T=7 days);

Two replicas were made for each condition.

Yeast growth is measured by reading the optical density at 550 nanometers.

Optical densities are summarized in FIG. 3B.

It should be noted that the populations of all three strains of Brettanomyces bruxellensis are particularly sensitive to the product according to the invention at all times: no strain of Brettanomyces grows in the presence of the product according to the invention, whatever the weather.

From T=3 days, the effects in the presence of inactivated product according to the invention are similar to those of ethanol.

Based on the two tests presented in this example, it appears that amphidinol 18 is a particularly effective amphidinol for controlling and/or limiting the growth of Brettanomyces bruxellensis.

### Example 5: Determination of the Minimum Inhibitory Concentration of the Product According to the Invention at Different Concentrations of Brettanomyces bruxellensis

The minimum inhibitory concentration of the product according to the invention was determined for three concentrations of Brettanomyces bruxellensis: 2.5·102 CFU/mL, 2.5·103 CFU/mL and 2.5·104 CFU/mL according to the protocol described in Example 2 and FIG. 1B.

OD550 nm at 0, 3, 5 and 6 days (T0, T3, T5 and T6) was measured after yeast incubation at 28° C. in the presence of YPD medium alone (negative control), ethanol or in the presence of the product according to the invention at a final concentration of 0.03 g/L to 0.25 g/L. Two replicas were made for each condition.

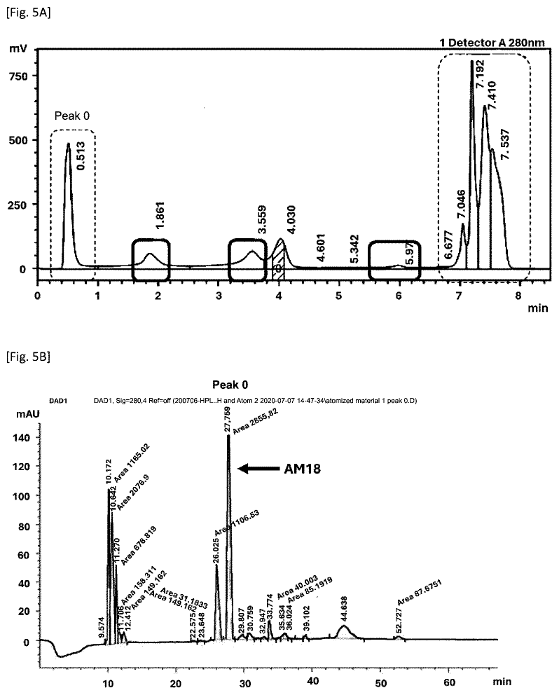

The summary of the optical densities is given in FIG. 4.

Regardless of the concentration of Brettanomyces bruxellensis, a concentration of 0.125 g/L ICC001 is highly effective at inhibiting Brettanomyces bruxellensis.

### Example 6: Determination of the Minimum Inhibitory Concentration of a Purified Fraction of the Product According to the Invention on Brettanomyces bruxellensis

The chromatographic data for the product according to the invention after injection into the high-performance liquid chromatography column are given in FIG. 5A.

The analysis of peak 0 by tandem mass spectrometry (MS/MS) is given in FIG. 5B. The peak at 27.759 corresponds to amphidinol 18 (AM18).

The photo of the peak 0 fraction and the product according to the invention is given in FIG. 5C.

The minimum inhibitory concentration of peak 0 (purified fraction) was determined for two strains of Brettanomyces bruxellensis (NL6293 and NL6300) according to the protocol described in Example 2 and FIG. 1B.

OD550 nm at T=0 days, T=3 days and T=6 days was measured after incubation of yeasts at 28° C. in the presence of YPD medium alone (negative control), methanol or in the presence of peak 0 at dilutions ranging from 1:32 to 1:256 corresponding to concentrations of 40 to 5 ppm of amphidinol 18. The product according to the invention at 0.25 g/L was also tested (positive control). Two replicas were produced.

The data set obtained is given in FIG. 5D.

All dilutions and the product according to the invention (0.25 g/L) were shown to be effective against strain NL6293.

It was also demonstrated that all concentrations except the 5 ppm concentration of AM18 as well as the product according to the invention (0.25 g/L), are effective against strain NL6300.

### Example 7: Determination of the Minimum Inhibitory Concentration of a Purified Fraction of the Product According to the Invention on the Yeast Saccharomyces cerevisiae

The minimum inhibitory concentration (MIC) of peak 0 described in FIG. 5D was determined for Saccharomyces cerevisiae according to the protocol described in Example 2 and FIG. 1B.

OD550 nm at 0, 3 and 6 days (T0, T3 and T6) was measured after incubation at 28° C. of yeasts at 2.5·104 CFU/mL in the presence of YPD medium alone (negative control), methanol (MEtOH) or in the presence of peak 0 at a dilution of 1:32 to 1:256 corresponding to concentrations of 40 to 5 ppm of amphidinol 18. The product according to the invention at 0.25 g/L was also tested under the same conditions. Two replicas (rep1 and rep2) were produced.

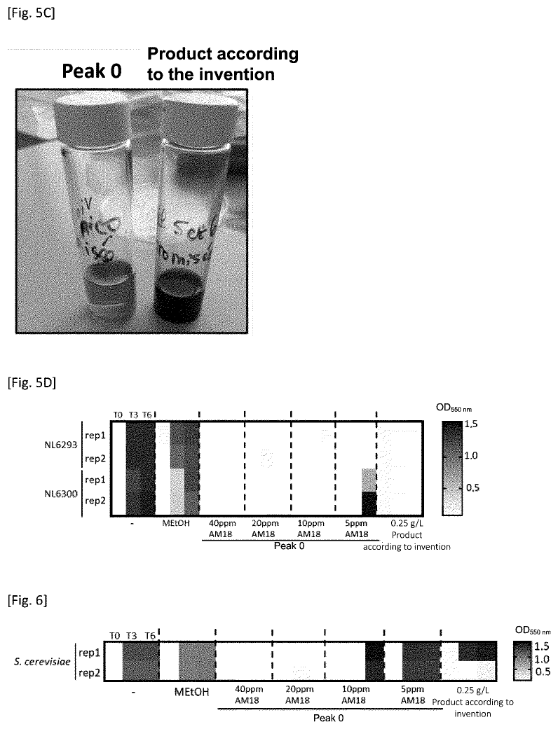

The data set obtained is given in FIG. 6.

Concentrations of 40 and 20 ppm of AM18 and the product according to the invention (0.25 g/L) have been shown to be effective against Saccharomyces cerevisiae.

### Example 8: Determination of the Minimum Inhibitory Concentration of a Purified Fraction of the Product According to the Invention on the Bacterium Acetobacter aceti

The minimum inhibitory concentration (MIC) of peak 0 described in FIG. 5D was determined for Acetobacter aceti according to the protocol described in Example 2 and FIG. 1B.

OD550 nm at 0, 3 and 6 days (T0, T3 and T6) was measured after incubation at 28° C. of yeasts at 10⁵ CFU/mL in the presence of MRS medium alone (negative control), methanol (MEtOH) or in the presence of peak 0 at a dilution of 1:32 to 1:256 corresponding to concentrations of 40 to 5 ppm of amphidinol 18. The product according to the invention at 0.25 g/L was also tested under the same conditions. Two replicas (rep1 and rep2) were carried out.

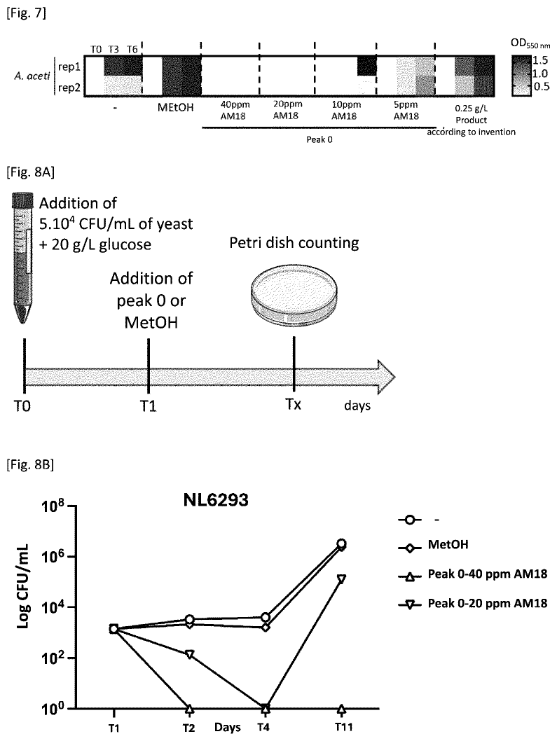

The data set obtained is given in FIG. 7.

Concentrations of 40, 20 and 10 pp: of AM18 and the product according to the invention (0.25 g/L) were shown to be effective against Acetobacter aceti.

### Example 9: Study of the Antimicrobial Action of the Purified Fraction of the Product According to the Invention on Brettanomyces bruxellensis and Saccharomyces cerevisiae in Wine

At time T0, unsulfited wine previously heated to 100° C. for 5 min and then supplemented with 20 g/L glucose was inoculated with Brettanomyces bruxellensis, strain NL6293 or NL6300, or else with Saccharomyces cerevisiae at a final concentration of 5·104 CFU/mL.

After 24 hours of incubation at room temperature and in the dark (T1), 500 μL of these samples were inoculated with 1:32 of YPD medium (negative control) or 1:32 of methanol or 1:32 or 1:64 of the peak 0 purified fraction of the product according to the invention.

These samples are incubated at room temperature and in the dark with gentle agitation.

At the times indicated (T=1 day, T=2 days, T=4 days and T=11 days), 10 μL of each sample is taken in order to determine the amount of colony-forming yeast units (CFU) by Petri dish counting.

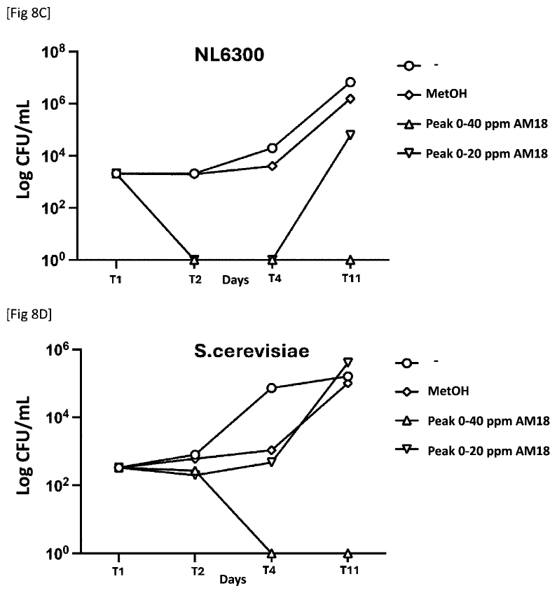

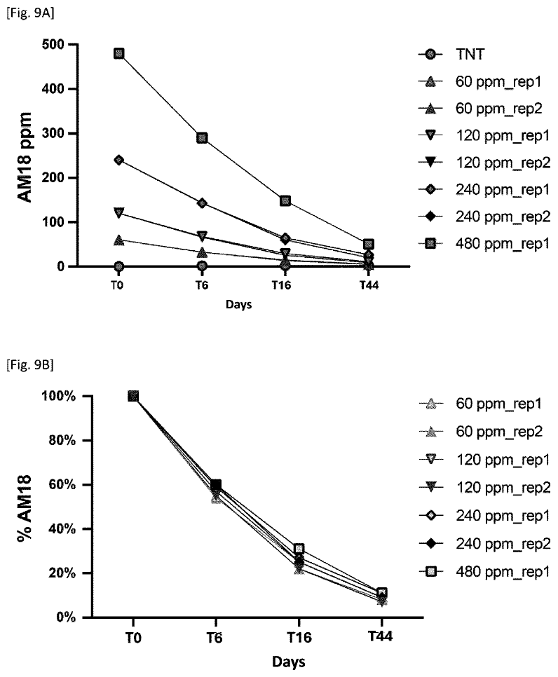

The data collected have been arranged in FIGS. 8A, 8B and 8C.

The logarithmic measurement of the number of colony-forming units (log CFU/mL) of Brettanomyces bruxellensis NL6293 present in the wine at T=1 day, T=2 days, T=4 days and T=11 days after inoculation of the wine with Brettanomyces bruxellensis NL6293 for the different conditions described is given in FIG. 8B.

In the presence of YPD medium (negative control), the growth of CFU is exponential from T=4 days.

In the presence of methanol, the growth of CFU is in the exponential phase from T=4 days.

In the presence of 1:32 of the purified fraction of the product according to the invention, no growth of CFU, at T=2 days no viable CFU is detected.

In the presence of 1:64 of the purified fraction of the product according to the invention, no viable CFU is detected at T=4 days, but viable CFU growth becomes detectable at T=11 days.

In summary, the purified fraction of the product according to the invention is highly effective against Brettanomyces bruxellensis NL6293 in wine.

The logarithmic measurement of the number of colony-forming units (log CFU/mL) of Brettanomyces bruxellensis NL6300 present in the wine at T=1 day, T=2 days, T=4 days and T=11 days after inoculation of the wine with Brettanomyces bruxellensis NL6300 for the different conditions described is given in FIG. 8C.

In the presence of YPD medium (negative control), the growth of CFU is exponential from T=4 days.

In the presence of methanol, the growth of CFU is in the exponential phase from T=4 days.

In the presence of 1:32 of the purified fraction of the product according to the invention, no growth of CFU, at T=2 days no viable CFU is detected.

In the presence of 1:64 of the purified fraction of the product according to the invention, no viable CFU is detected at T=4 days, but viable CFU growth becomes detectable at T=11 days.

In summary, the purified fraction of the product according to the invention is highly effective against Brettanomyces bruxellensis NL6300 in wine.

The logarithmic measurement of the number of colony-forming units (log CFU/mL) of Saccharomyces cerevisiae present in the wine at T=1 day, T=2 days, T=4 days and T=11 days after inoculation of the wine with Saccharomyces cerevisiae for the different conditions described is given in FIG. 8D.

In the presence of YPD medium (negative control), the growth of CFU is very strong from T=2 days.

In the presence of methanol, the growth of CFU starts at T=2 days.

In the presence of 1:32 of the purified fraction of the product according to the invention, no growth of CFU is observed, and at T=4 days no viable CFU is detected.

In the presence of 1:64 of the purified fraction of the product according to the invention, the CFU are stabilized up to T=4 days.

In summary, the purified fraction of the product according to the invention is highly effective against Saccharomyces cerevisiae in wine.

### Example 10: Study of the Degradation Kinetics of Amphidinol 18 in Wine

Different doses of the product according to the invention, containing from 60 ppm to 480 ppm of amphidinol 18, were inoculated in the wine. The amount of amphidinol 18 was determined by HPLC assay over time, up to day 44 (T44). The percentage of amphidinol 18 with respect to the initial dose was assessed over time.

These results are described in FIGS. 9A and 9B.

This example shows that amphidinol 18 degrades steadily in wine. After 44 days in wine, similar amounts of amphidinol were found, irrespective of the initial concentration.

### Example 11: Study of the Yeasticidal Activity of a Product According to the Invention in Wine

A natural wine containing yeast was treated either with the product according to the invention comprising 10 ppm of amphidinol 18 (AM18), or with a commercial dose of chitosan. An untreated control (TNT) was also carried out.

The yeast and bacteria present in each condition were counted by epifluorescence observation before treatment (DO) and 3 days after treatment (D3).

The results of this example are shown in FIG. 11.

It can be observed that the product according to the invention comprising amphidinol 18 has a better bactericidal and yeasticidal efficacy than chitosan after 3 days of treatment.

### Example 12: Study of the Activity of the Product According to the Invention to Control and/or Limit the Growth of Yeasts Belonging to the Brettanomyces Genus Under Acid pH Conditions

The strains of Brettanomyces (NL6293 and NL6200) at a concentration of 2.5 105 CFU/mL were incubated in the presence of a concentration range of the product according to the invention in YPD medium at different pH values. A minimum concentration of the product according to the invention inducing 100% yeast inhibition (MIC) could be determined in each condition. The results are presented in Table 1 below.

TABLE 1

| | MIC | | |
|---|---|---|---|
| Brettanomyces | pH 3.7 | pH 4.0 | pH 6.5 |
| NL6293 | 0.03 | 0.015 | 0.015 |
| NL6200 | 0.03 | 0.03 | 0.03 |

These results indicate that the product according to the invention retains its ability to control and/or limit the growth of yeast belonging to the Brettanomyces genus at acid pH.

### Example 13: Determination of the Effect of the Product According to the Invention on the Growth of Acetobacter aceti in Wine

The product according to the invention used in this example is obtained using the method described in Example 1.

For this example, unsulfited red wine was used to measure Acetobacter Aceti growth over time.

6×50 mL samples were collected under sterile conditions and placed in 200 mL Erlenmeyer flasks.

A sample is directly isolated for qPCR analysis of acetic bacteria concentration.

The other 5 samples are placed at 28° C. under stirring for 1 hour, then a concentration of product according to the invention ranging from 5 ppm to 40 ppm is added.

The concentration of Acetobacter Aceti is then measured 7 days and 14 days after treatment with the product according to the invention.

The results of this example are shown in FIG. 12 and demonstrate the inhibitory effect of the product according to the invention on the growth of Acetobacter Aceti, notably at concentrations of 20 and 40 ppm.

As a result, the product according to the invention is highly effective against Acetobacter Aceti in wine.

### Example 14: Determination of the Effect of the Product According to the Invention on the Growth of Oenococcus oenii in Wine

The product according to the invention used in this example is obtained using the method described in Example 1.

For this example, a red wine was sampled during malolactic fermentation to measure the growth of Oenococcus oenii over time.

6×5 mL samples were collected under sterile conditions and placed in 200 mL Erlenmeyer flasks.

A sample is directly isolated for qPCR analysis of malolactic bacteria concentration.

The other 5 samples are placed at 18° C. under stirring for 1 hour, then a concentration of product according to the invention ranging from 5 ppm to 40 ppm is added.

The concentration of Oenococcus oenii is then measured up to 7 days after treatment with the product according to the invention.

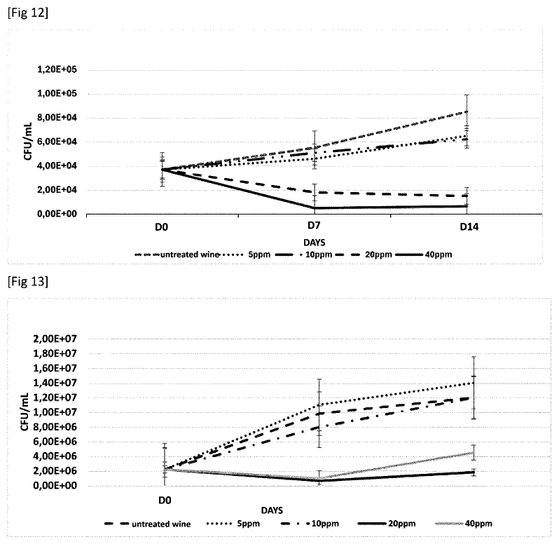

The results of this example are shown in FIG. 13 and demonstrate the growth-inhibiting effect of Oenococcus oenii by the product according to the invention, notably at concentrations of 20 and 40 ppm.

As a result, the product according to the invention is highly effective against Oenococcus oenii in wine.

### Example 15: Determination of the Effect of the Product According to the Invention on the Growth of Saccharomyces cerevisiae in a Non-Alcoholic Beverage

The aim of this example is to demonstrate the yeasticidal properties of the product according to the invention, notably its amphidinol 18 content, on pasteurized grape juice (equivalent to pre-fermented grape must), apple juice or multi-fruit juice.

For this example, 10 mL of apple juice, grape juice or multifruit juice was inoculated with a strain of Saccharomyces cerevisiae at 60,000 cells per mL, that is a deposit of 17 μL of inoculum per 10 ml tube for Ci at T0=10⁰ cells/mL.

These inoculated juices were incubated statically at 20° C., under subdued light, after having been pre-treated as follows:
1. Untreated (Negative control)
2. Ethanol 1.18%
3. Ethanol 2.37%
4. Ethanol 4.74%
5. 100 ppm Chitosan
6. 9 ppm Amphidinol 18 (AM18)
7. 18 ppm Amphidinol 18 (AM18)
8. 36 ppm Amphidinol 18 (AM18)

The amphidinol concentration is obtained using the product according to the invention obtained from Example 1. The amount of product according to the invention is adjusted to obtain the desired amphidinol concentrations.

The biomass of Saccharomyces populations was measured by optical density reading at 600 nm.

The results of this example are shown in Table 2 below.

TABLE 2

| | | Average | Average | Average | Average |
|---|---|---|---|---|---|
| Matrix | Conditions | D0 | D1 | D2 | D3 |
| Apple | Untreated | 0.012 | 0.0035 | 1.102 | 1.819 |
| Apple | Ethanol 1.18% | 0.006 | −0.0005 | 0.7505 | 1.7765 |
| Apple | Ethanol 2.37% | 0.0105 | −0.0155 | 0.6175 | 1.7885 |
| Apple | Ethanol 4.74% | −0.003 | −0.0235 | 0.0945 | 1.483 |
| Apple | 100 ppm | −0.0055 | −0.007 | 0.7245 | 1.778 |
| | Chitosan | | | | |
| Apple | 9 ppm AM18 | −0.1305 | −0.1655 | 0.1385 | 0.6495 |
| Apple | 18 ppm AM18 | 0.0835 | 0.0055 | −0.0505 | −0.091 |
| Apple | 36 ppm AM18 | −0.012 | −0.007 | −0.062 | 0.3515 |
| Grape | Untreated | 0.0205 | −0.0005 | 0.629 | 2.4485 |
| Grape | Ethanol 1.18% | 0 | −0.0035 | 0.3575 | 2.0795 |
| Grape | Ethanol 2.37% | 0.0005 | −0.0055 | 0.242 | 1.942 |
| Grape | Ethanol 4.74% | 0.031 | −0.0145 | 0.0605 | 1.1825 |
| Grape | Chitosan | 0.0185 | −0.0035 | 0.295 | 2.096 |
| Grape | 9 ppm AM18 | 0.0755 | 0.0375 | 0.0315 | −0.084 |
| Grape | 18 ppm AM18 | 0.2065 | 0.175 | 0.154 | 0.0515 |
| Grape | 36 ppm AM18 | −0.1485 | −0.174 | −0.2285 | −0.2465 |
| Multifruit | Untreated | 0.0165 | 0.0925 | 0.079 | 0.1845 |
| Multifruit | Ethanol 1.18% | 0.008 | 0.0615 | 0.0395 | 0.14 |
| Multifruit | Ethanol 2.37% | 0.0035 | 0.0605 | 0.0665 | 0.1295 |
| Multifruit | Ethanol 4.74% | −0.0595 | 0.014 | −0.0285 | 0.1105 |
| Multifruit | 100 ppm | −0.008 | −0.026 | 0.0735 | 0.1125 |
| | Chitosan | | | | |
| Multifruit | 9 ppm AM18 | −0.006 | −0.028 | −0.0705 | 0.0995 |
| Multifruit | 18 ppm AM18 | 0.002 | −0.0365 | −0.0155 | 0.033 |
| Multifruit | 36 ppm AM18 | −0.009 | 0.034 | 0.008 | 0.018 |

Table 2 hereinbefore shows the results obtained for each type of juice processed. In the untreated control conditions, Saccharomyces cerevisiae showed strong population growth 48 hours after inoculation.

For all the juices tested, the product according to the invention, via its amphidinol 18 content, enabled total inhibition of yeast growth, as early as 9 ppm. The results obtained are equivalent to treatment with ethanol at 4.74% and superior to treatment with Chitosan or ethanol at 1.18% and 2.37% final concentration. Three days after inoculation, only batches treated with the product according to the invention or with 4.74% ethanol showed no yeast population growth, whereas exponential growth was observed under the other conditions.

This example demonstrates an action of the product according to the invention via its amphidinol 18 concentration, this molecule completely preventing the growth of Saccharomyces populations in 3 types of fruit juice.

1. A use of a product comprising at least one amphidinol in an alcoholic beverage or in a non-alcoholic beverage.

2. The use according to claim 1, as a sulfite substitute.

3. The use according to claim 1, characterized in that the alcoholic beverage has a pH of less than 7, preferentially less than 4.

4. The use according to claim 1, characterized in that the alcoholic beverage comprises at least 1% ethyl alcohol, preferentially at least 4%.

5. The use according to claim 1, characterized in that the product comprises at least one amphidinol selected from amphidinol 1 to 19, amphidinol 22, amphidinol A and mixtures thereof.

6. The use according to claim 2, characterized in that the alcoholic beverage is a beverage obtained by alcoholic fermentation.

7. The use according to claim 1, characterized in that the alcoholic beverage is selected from wine, cider and beer, or the non-alcoholic beverage is a fruit juice.

8. (canceled)

9. The use according to claim 1, as a bactericide, yeasticide and/or antioxidant.

10. The use according to claim 1, in an alcoholic beverage or in a non-alcoholic beverage for controlling and/or limiting the growth of at least one yeast of a genus selected from Brettanomyces, Hansenula, Saccharomyces, Hanseniaspora, Pichia, Candida, Kloeckera and combinations thereof.

11. (canceled)

12. The use according to claim 1, in an alcoholic beverage, to control and/or limit the growth of at least one bacterium of a genus selected from Gluconobacter, Acetobacter, Oenococcus, Lactobacillus, Pediococcus, Pectinatus, Megasphaera, Citrobacter, Enterobacter, Obesumbacterium, Klebsiella, Proteus, Serratia, Zymomonas.

13. The use according to claim 1, characterized in that the product is in powder form or liquid form.

14. A product for use in alcoholic beverages, comprising at least one amphidinol.

15. The product according to claim 14, characterized in that it comprises at least one amphidinol from amphidinol 1 to 19, amphidinol 22, amphidinol A and mixtures thereof and/or the product comprises a cell extract of one or more microalgae of the Amphidinium genus.

16. (canceled)

17. The product according to claim 16, characterized in that said microalgae of the Amphidinium genus is Amphidinium carterae and/or the product does not comprise carteraol.

18. (canceled)

19. A method for manufacturing an alcoholic beverage or a non-alcoholic beverage, comprising at least one step of adding at least one amphidinol to the beverage.

20. The method according to claim 19, characterized in that the alcoholic beverage is selected from wine, cider and beer, or the non-alcoholic beverage is a fruit juice.

21. (canceled)

22. The method according to claim 19, comprising a step of adding at least one amphidinol selected from amphidinol 1 to 19, amphidinol 22, amphidinol A and mixtures thereof.

23. (canceled)

24. An alcoholic or non-alcoholic beverage comprising the product of claim 14.

25. The alcoholic or non-alcoholic beverage according to claim 24, characterized in that it the alcoholic or non-alcoholic beverage comprises at least one amphidinol selected from amphidinol 1 to 19, amphidinol 22, amphidinol A and mixtures thereof and/or the alcoholic or non-alcoholic beverage does not comprise added sulfites.

26. (canceled)

27. (canceled)

28. The method of claim 19, wherein adding the at least one amphidinol controls and/or limits growth of at least one undesirable microorganism.
